(19) United States
(12) Patent Application Publication
(10) Pub. No.: US 2024/0336059 A1
(43) Pub. Date: Oct. 10, 2024

(54) AN INK RESERVOIR AND DOCTOR BLADE ASSEMBLY

(71) Applicant: Primeblade Sweden AB, Sunne (SE)

(72) Inventor: Kaplan Bartek, SOLLENTUNA (SE)

(73) Assignee: Primeblade Sweden AB, Sunne (SE)

(21) Appl. No.: 18/291,629

(22) PCT Filed: Sep. 14, 2022
(86) PCT No.: PCT/EP2022/075555

§ 371 Date: Jan. 24, 2024

(30) Foreign Application Priority Data
Sep. 14, 2021 (SE) 2151130-8

(51) Int. Cl. B41F 31/02; B41F 3/81; B41F 5/24; B41F 9/06; B41F 31/04; B41F 31/06

(52) U.S. Cl. CPC B41F 31/027; B41F 3/81; B41F 5/24; B41F 9/068; B41F 31/04; B41F 31/06

(57) ABSTRACT

The invention provides a combination of an ink reservoir and doctor blade assembly (2) and a rotatable cylinder (3) for a printing press, which form a chamber for containing ink, —wherein the ink reservoir and doctor blade assembly (2) comprises a scaling assembly (203) for scaling an axial end of the chamber, or sealing a sub-chamber of the chamber from another sub-chamber of the chamber, —wherein the sealing assembly (203) comprises a seal (2031) presenting a seal contour (SC) to sealingly engage a circumferential surface of the cylinder (3), and a flexible biasing device (2032) forming one or more cavities (2041-2043), and being arranged to receive a pressurized fluid in the one or more cavities (2041-2043), for biasing the seal (2031) into sealing engagement with the cylinder (3), —wherein the combination is arranged according to one or both of the following alternatives (a) and (b): —(a): in an axis perpendicular plane, which is perpendicular to the rotational axis of the cylinder (3) and coincides with a cross-section of the biasing device, the biasing device (2032) has a peak (2032P) or a summit (2032S) which is located within an extension (EXTSC) of the seal contour (SC) along a reference plane (RP) which coincides with the rotational axis of the cylinder (3) and which is perpendicular to a seal location plane (SLP) which coincides with the rotational axis of the cylinder (3) and a circumferential mid-point of the seal contour (SC), —(b): the biasing device presents one or more surfaces which extend, in the axis perpendicular plane, in parallel with the seal location plane (SLP), and which face at least partly away from the seal location plane (SLP), and/or one or more surfaces which face partly away from the reference plane (RP), and the seal (2031) covers any such surface.

### TECHNICAL FIELD

The invention relates to a combination of an ink reservoir and doctor blade assembly and a rotatable cylinder for a printing press, to an ink reservoir and doctor blade assembly, to a sealing assembly for an ink reservoir and doctor blade assembly, to a reservoir assembly for a printing press, and to a printing press. The invention may be used for a flexographic printing process. However, the present invention is useful also in other contexts where it is desired to effect a seal with respect to a rotating cylinder. Thus, although the invention is described in the context of a flexographic printing press, the invention is not limited to use in such devices.

### BACKGROUND

Flexographic printing is a rotary letter press printing process which traditionally uses flexible rubber, or other elastomer, printing plates and liquid, fast drying ink.

As described in U.S. Pat. No. 5,243,907A, in flexographic printing, a web to be imprinted is passed between an impression cylinder and a plate cylinder, from which the ink is transferred to the web. Ink is applied to the plate cylinder by an anilox metering roll. The circumferential surface of the anilox roll forms a large number of small cells. Ink is fed to the anilox roll by a chambered doctor blade assembly. Thereby, the ink fills the cells of the surface of the anilox roll. The chambered doctor blade assembly typically comprises a base forming an elongated cavity, and a pair of doctor blades which contact the anilox roll. The chambered doctor blade assembly may also comprise a sealing assembly at each end of the chamber, herein referred to as an end sealing assembly. The surface of the anilox roll, and the chambered doctor blade assembly define a closed chamber for containing the ink. Thereby, the doctor blades are distributed in the circumferential direction of the anilox roll. Thereby, the doctor blades delimit the exposure of the anilox roll to the chamber. As the anilox roll rotates, the doctor blades shave surplus ink from the surface of the anilox roll. As a result, ink is carried only in the interior of the cells on the roll's surface and not on the lands between cells. This results in a uniformly metered quantity of ink being applied to the surface of the plate cylinder.

Said US patent suggests that in cases where it is desired to print more than one color on a web, which requires more than one color of ink, said ink chamber is divided into two or more sub-chambers by one or more dividers. These dividers are designed to maintain a fluid-tight seal between compartments in the ink fountain and to maintain a seal against the anilox roll. Each seal is contoured to sealingly engage the circumferential surface of the roll. A seal retainer is provided for retaining the seal in sealing engagement with the roll. A pneumatic bladder acts on the seal retainer for resiliently biasing the seal into sealing engagement with the roll.

A problem with such a solution is that the seal may wear unevenly.

Another problem with such a solution is that the seal may deform due to the rotation of the cylinder.

DE102006009084A1 describes an ink train for an anilox roller with a bellows-like rubber-elastic expansion element with a cavity. The expansion element extends circumferentially along the roller as well as laterally across doctor blades of the ink train. An elastomeric foam is provided between the expansion element and the roller.

Thereby, a problem is that a relatively high sealing pressure against the doctor blade may force the blades against the roller, in turn causing the blades to wear unevenly along their lengths.

### SUMMARY

An object of the invention is to provide a durable and reliable sealing function of an ink reservoir, e.g. for flexographic printing.

The object is achieved by a combination of an ink reservoir and doctor blade assembly and a rotatable cylinder for a printing press,
the ink reservoir and doctor blade assembly comprising a base extending in the direction of the rotational axis of the cylinder,
the ink reservoir and doctor blade assembly further comprising one or more doctor blades which are fixed to the base,
wherein cylinder, and the ink reservoir and doctor blade assembly form a chamber for containing ink,
wherein the ink reservoir and doctor blade assembly comprises a sealing assembly for sealing an axial end of the chamber, or sealing a sub-chamber of the chamber from another sub-chamber of the chamber,
wherein the sealing assembly comprises a seal presenting a seal contour to sealingly engage a circumferential surface of the cylinder, and a flexible biasing device forming at least one cavity, and being arranged to receive a pressurized fluid in the cavity, for biasing the seal into sealing engagement with the cylinder.

The combination is arranged according to one or both of the following alternatives (a) and (b):
(a): in an axis perpendicular plane, which is perpendicular to the rotational axis of the cylinder and coincides with a cross-section of the biasing device, the biasing device has a peak or a summit which is located within an extension of the seal contour along a reference plane which coincides with the rotational axis of the cylinder and which is perpendicular to a seal location plane which coincides with the rotational axis of the cylinder and a circumferential mid-point of the seal contour,
(b): the biasing device presents one or more surfaces which extend, in the axis perpendicular plane, in parallel with the seal location plane, and which at least partly face away from the seal location plane, and/or one or more surfaces which face partly away from the reference plane, and the seal covers any such surface.

The rotatable cylinder may be an anilox roll for a printing press, e.g. for flexographic printing. In a printing press, the ink reservoir and doctor blade assembly in any circumferential position in relation to the cylinder, e.g. below the cylinder, or laterally to the cylinder. The ink reservoir and doctor blade assembly may be arranged to be biased towards the cylinder.

The base may comprise two walls connected by a root. The base may form a channel for holding the ink. The ink may be for a printing process of the printing press. The base may form an elongated cavity extending along the axial direction of the cylinder. The base may form a part of the chamber for the ink.

The doctor blade may be fixed to a wall of the base. The doctor blade may extend along the rotating cylinder. The doctor blade may form a part of the chamber for the ink. As suggested below, in some embodiments, the assembly comprises two doctor blades. The doctor blade may be in contact with the rotatable cylinder. However, it is conceivable that there are embodiments with a distance, although preferably small, between the doctor blade and the cylinder.

The seal may be in direct contact with the cylinder. The sealing assembly may be provided for sealing an end of the chamber at an axial end of the cylinder. The ink reservoir and doctor blade assembly may have two sealing assemblies, one at each end of the assembly. The base, the doctor blade, and the sealing assembly/-ies may form a container for the ink.

The seal contour may extend along a part of the circumference of the cylinder. The seal contour may extend along at least 5 degrees, preferably at least 10 degrees, or more preferably at least 15 degrees of the circumference of the cylinder. Preferably, the seal contour extends no more than 100 degrees, more preferably no more than 80 degrees, along the circumference of the cylinder.

The flexible biasing device may be provided in the form of a bladder. The pressurized fluid for the at least one cavity formed by the biasing may be a gas, e.g. air, or a liquid, e.g. hydraulic oil.

It is understood that the axis perpendicular plane, which is perpendicular to the rotational axis of the cylinder, has a normal which is parallel with the cylinder rotational axis. The axis perpendicular plane coincides with a cross-section of the biasing device which is perpendicular to the cylinder rotational axis.

The biasing device may present a work surface which faces at least partly towards the cylinder. At least a part of the work surface may form the peak or summit according to alternative (a). The peak or summit according to alternative (a) may point towards the cylinder.

The reference plane and the seal location plane may contain the rotational axis of the cylinder. The peak or summit according to alternative (a) is preferably located entirely within the extension of the seal contour along the reference plane. The peak or summit is preferably, compared to other parts of the biasing device, positioned closer to the reference plane.

It is understood that in alternative (b), the seal covers the biasing device on any surface which extends, in a cross-section which is perpendicular to the cylinder rotational axis, in parallel with the seal location plane, and which at least partly faces away from the seal location plane, and on any which faces partly away from the reference plane. In some embodiments, the seal covers one or more of the surfaces of the biasing device which extend in parallel with the rotational axis of the cylinder and face partly away from the reference plane. The seal may cover one or more surfaces which are parallel with the seal location plane and face away from the seal location plane.

Advantageously, the entire biasing device is within the extension of the seal contour along the reference plane.

Alternatively, one or more parts of the biasing device is located outside of the extension of the seal contour along the reference plane.

By the biasing device it is possible to bias end seals, or divider seals, of an ink reservoir and doctor blade assembly, towards the cylinder, to compensate for wear of the seals. An alternative measure of compensating seal wear by biasing the entire ink reservoir and doctor blade assembly towards the cylinder may entail increasing the pressure of one or more doctor blades of the assembly against the cylinder, which may increase their wear, and prevent a correct function of the blades due to an incorrect contact angle of blade edges against the cylinder. Such an alternative measure can be avoided by use of biasing devices in ink reservoir and doctor blade assemblies according to embodiments of the invention.

Preferably, the seal is made of a flexible material. By the seal being made of a flexible material, the seal may readily adapt to the cylinder. Also, the flexibility may allow adaption to any uneven wear of the seal. However, the biasing device allows for providing a flexible seal while limiting its deformation by the biasing of the seal towards the cylinder. Thereby, a durable and reliable sealing function is provided.

With the feature of alternative (a), the biasing device may reach closer to the cylinder than to the doctor blades.

With the feature of alternative (b), the seal will be present between the biasing device and side walls of the base of the assembly. Thereby, the biasing device may be positioned centrally in the sealing assembly.

By the biasing device may reaching closer to the cylinder than to the doctor blades, and/or being positioned centrally in the sealing assembly, the seal may be biased harder against the cylinder than against the doctor blades. Thereby, said problem with a relatively high sealing pressure against the doctor blade forcing the blade against the cylinder, in turn causing the blade to wear unevenly along their lengths, can be avoided, while securing that the seal is biased with a relatively high pressure against the cylinder.

Thereby, the invention provides a durable and reliable sealing function for an ink reservoir.

Preferably, the seal forms a single element. Thereby, the seal may form a single uniform element. The seal may be formed as a single piece. In such embodiments, the seal is not formed by more than one separately formed element. All parts of the seal may have the same material characteristics, such as the same density and the same Young's modulus.

Preferably, the biasing device has external walls with a thickness of no more than 2% of the extension of the sealing assembly along the reference plane. Preferably, extension of the biasing device along the reference plane is no more than 90%, preferably no more than 80%, of the extension of the sealing assembly along the reference plane. Preferably, the shortest distance between the biasing device and the doctor blade is at least 1%, preferably at least 5%, more preferably at least 10%, of the extension of the sealing assembly along the reference plane. Preferably, the shortest distance between the biasing device and the cylinder is at least 1%, preferably at least 5%, more preferably at least 10%, of the extension of the sealing assembly along the reference plane. Preferably the shortest distance between the biasing device and the cylinder is no more than 75%, preferably no more than 65%, of the shortest distance between the biasing device and the doctor blade, when the ink reservoir and doctor blade assembly is mounted to the cylinder.

Preferably, in alternative (a), the peak of the biasing device is at, or in the vicinity of, the seal location plane. Thereby, the distance from the work surface of the biasing device to the reference plane is shorter at the seal location plane than at a distance from the seal location plane. This will counteract a rotation of the seal due to the cylinder rotation in a particularly effective manner. Thereby, one of the declinations on opposite sides of the peak may form the engagement surface.

In some embodiments including the feature of alternative (b), in the axis perpendicular plane, the seal fully encloses the biasing device. Thereby, the seal may fully surround the biasing device in the axis perpendicular plane.

In some embodiments including the feature of alternative (b), the biasing device is positioned with a backside thereof adjacent the base, and is, in the axis perpendicular plane, surrounded by the seal at the remaining sides of the biasing device. The backside of the biasing device may thereby face fully away from the reference plane. The seal may thereby partly surround the biasing device.

Thus, the biasing device may be positioned between the base and the seal, or within said seal.

In some embodiments, the shortest distance from the biasing device to the cylinder is smaller than the shortest distance from the biasing device to the one or more doctor blades.

Preferably, the seal forms a single element. Thereby, the seal may form a single uniform element. The seal may be formed as a single piece. In such embodiments, the seal is not formed by more than one separately formed element. All parts of the seal may have the same material characteristics, such as the same density and the same Young's modulus.

Preferably, the seal and the biasing device are separate elements. Thus, the biasing device and the seal may be formed as separate parts. Thereby, it is possible to separate them, e.g. for replacing one of them. However, even if the biasing device and the seal are formed as separate parts, they may be attached to each other. For example, they may be attached by being glued to each other. In some embodiments, the biasing device is manufactured in the following manner: The seal is provided with a cavity, and on the surface or surfaces of the cavity a material for the biasing device, such as a rubber material, is applied or deposited. The applied or deposited material forms the biasing device, e.g. upon hardening after having been applied or deposited. Nevertheless, also in such embodiments, the biasing device and the seal may be formed as separate parts.

The biasing device and the seal may be made in different materials. Thus, the material of the seal may be different from the material of the biasing device. In some embodiments, the biasing device and the seal may be made in the same material, having different densities. Where the biasing device includes more than one material, all of these materials may be different from any material of the seal, and/or have densities that are different from the density of any material of the seal. Where the seal includes more than one material, all of these materials may be different from any material of the biasing device, and/or have densities that are different from the density of any material of the biasing device.

Preferably, the biasing device is in direct contact with the seal. Thereby, by the flexibility of the seal, and the flexibility of the biasing device, an adaption of the contact of the seal to the cylinder, may be provided. Thereby, the sealing function may be retained as the seal wears, e.g. due to its contact with the rotating cylinder.

Preferably, the seal is in direct contact with the one or more doctor blades. Thereby, where the one or more doctor blades are in contact with the cylinder, the seal may be in direct contact with the one or more doctor blades as well as with the cylinder. Thereby the seal may extend from the cylinder to the one or more doctor blades. Thereby, an effective sealing function is provided.

In some embodiments, the ink reservoir and doctor blade assembly may comprise two doctor blades. The doctor blades may be arranged to be distributed circumferentially in relation to the cylinder. The doctor blades may be in contact with the rotatable cylinder. Thereby, the seal contour may be arranged to sealingly engage the circumferential surface of the cylinder between the doctor blades. Thus, where there are two doctor blades, the seal contour may extend between the doctor blades. Thereby, the doctor blades may form, together with the rotating cylinder surface between them, the base, and sealing assemblies at the ends of the ink reservoir and doctor blade assembly, delimitations of the ink chamber. Thereby, the seals may seal, in addition to towards the cylinder, also towards the doctor blades. Thus, the seal may be in direct contact with both doctor blades.

Preferably, the material of the seal is a flexible foam material. Thereby, the advantageous flexibility of the seal is ensured. The foam material may be for example, polypropylene, polyethylene, polyurethane (PU55, PU85, PU100, PU110) foam, latex foam, High Resilience (HR) foam, a solid polymer, felt, an elastomer foam, or a combination of two or more of the these materials. The seal material may be lubricated with grease to limit friction and wear. In some embodiments, a surface of the seal, intended to face the rotatable cylinder is provided with a friction reducing coating, for example of PTFE.

Preferably, the Young's modulus of the seal material is equal to or less than 3000 MPa, preferably equal to or less than 2000 MPa, preferably equal to or less than 1300 MPa, preferably equal to or less than 500 MPa. Thereby, a sufficient flexibility of the seal may be ensured. Preferably, the Young's modulus of the flexible seal material is equal to or greater than 0.1 MPa, preferably equal to or greater than 0.2 MPa. Thereby, a sufficient rigidity of the seal may be ensured. Preferably, the Young's modulus is determined within a strain interval in which the stress to strain relationship for the material in question is substantially linear. For example, for polyurethane foam the Young's modulus may be given at 5% strain. For other materials, the Young's modulus is determined at a lower strain value.

Preferably, the Young's modulus of the flexible seal material is less than the Young's modulus of the base of the ink reservoir and doctor blade assembly, or less than the Young's modulus of a major portion of the base. Preferably, the Young's modulus of the flexible seal material is less than the Young's modulus of the rotatable cylinder, or less than the Young's modulus of a major portion of the rotatable cylinder.

The biasing device together with the seal preferably occupy the same space as a single unbiased end sealing assembly, thus enabling the use of a conventional ink reservoir and doctor blade assembly and removing the necessity of modifying or replacing said ink reservoir and doctor blade assembly.

In some embodiments, the biasing device forms at least two cavities and is arranged to receive the pressurized fluid in the cavities, for said biasing of the seal into sealing engagement with the cylinder. Thereby, the reservoir assembly comprises a pressurizing device connected to the biasing device, such that the pressure in one or more, but less than all, of the cavities, can be controlled independently of a control of the pressure in the remaining cavity or cavities. For example, a pressurizing device may be connected to the biasing device, such that the pressures in the cavities can be controlled individually. Thereby, an uneven wear of the seal may be compensated for. The cavities may be distributed laterally in relation to the direction of the cylinder rotational axis.

For example, the seal may be worn to a larger degree at its contact with the cylinder, than at its contact with the doctor blade(s) or the base. As another example, the seal may be worn to a larger degree at a certain cylinder circumferential position, compared to at another cylinder circumferential position. The pressures in the biasing device cavities may be differentiated to adjust the shape of a boundary between the biasing device and the seal. Facilitated by the flexible seal, the adjusted shape, of the boundary between the biasing device and the seal, may move seal material to a larger degree towards an area where the seal wear is larger than in other areas, than towards such other areas. This will provide a larger degree of seal wear compensation in positions where the seal is worn to a degree which is larger than the degree of wear at other positions.

A direct contact between the biasing device and the seal will secure a distribution of a biasing pressure to provide compensation for an uneven wear of the seal. Thereby, the flexibility of the seal will facilitate the adjustment of the worn seal. Thereby, a deformation of the worn seal, due to the cylinder rotation, can be avoided.

Advantageously, the seal extends along a surface of the biasing device, which surface, herein also referred to as an engagement surface, has a normal which is adapted to be, when the sealing device is mounted in the printing press, substantially perpendicular to an axial direction of the cylinder, and to be oriented so that the surface faces at least partly away from the seal location plane. The engagement surface may be parallel with the seal location plane, or face partly away from the reference plane.

Thereby, the engagement surface may face opposite to a direction of the cylinder surface movement caused by the rotation of the cylinder. Thereby, the engagement surface may prevent movements of the seal caused by friction between the seal and the moving cylinder surface. In other words, the engagement surface may provide a locking function of the seal to counteract tendencies of seal deformations due to the cylinder movement. Thereby, the advantageous flexibility of the seal may be provided while avoiding its deformation.

In some embodiments, at least a portion of a boundary between the biasing device and the seal has a curvature which is coaxial with the cylinder. Thereby the boundary follows the shape of the cylinder, as a radial distance therefrom. Thereby, a substantial even pressure of the seal towards the cylinder may be assured.

As suggested, the cylinder may be an anilox roll for a printing press for flexographic printing.

The object is also reached with an ink reservoir and doctor blade assembly for a combination of an ink reservoir and doctor blade assembly and a rotatable cylinder according to any embodiment of the invention. The object is also reached with a sealing assembly for such an ink reservoir and doctor blade assembly.

The object is also reached with a reservoir assembly for a printing press, wherein the reservoir assembly is adapted to form, with a rotatable cylinder of the printing press, a chamber for containing ink, the reservoir assembly comprising:
a base adapted to extend in the direction of the rotational axis of the cylinder,
a sealing assembly for sealing an axial end of the chamber, or sealing a sub-chamber of the chamber from another sub-chamber of the chamber,
wherein the sealing assembly comprises a seal adapted to present a seal contour to sealingly engage a circumferential surface of the cylinder,
and a flexible biasing device arranged to receive a pressurized fluid for biasing the seal into sealing engagement with the cylinder,
wherein the biasing device forms at least two cavities, for receive pressurized fluid,
wherein the reservoir assembly comprises a pressurizing device connected to the biasing device, such that the pressure in one or more, but less than all, of the cavities, can be controlled independently of a control of the pressure in the remaining cavity or cavities. In some embodiments, the pressures in the cavities can be controlled individually.

Advantages with such a reservoir assembly is understood from statements above. The larger degree of seal wear compensation in positions where the seal is worn to a degree which is larger than the degree of wear at other positions, will provide a durable and reliable sealing function.

Preferably, the biasing device is adapted so that the cavities are distributed in the circumferential direction of the cylinder.

Preferably, the seal is made of a flexible material, e.g. a flexible foam material. Preferably, the Young's modulus of the seal is equal to or less than 3000 MPa, preferably equal to or less than 2000 MPa, preferably equal to or less than 1300 MPa, preferably equal to or less than 500 MPa. Preferably, the Young's modulus of the seal is equal to or greater than 0.1 MPa, preferably equal to or greater than 0.2 MPa.

Preferably, the biasing device is in direct contact with the seal. Preferably, the biasing device is positioned between the base and the seal, or between upper and lower parts of the seal, or within the seal.

Preferably, the reservoir assembly is an ink reservoir and doctor blade assembly further comprising a doctor blade which is fixed to a wall of the base, the doctor blade being adapted to be in contact with the rotatable cylinder. Thereby, the ink reservoir and doctor blade assembly may form with the cylinder a chamber for containing ink. Thereby, the doctor blade may be fixed to a wall of the base, and arranged to be in contact with the rotatable cylinder. However, in some embodiments, the reservoir assembly may be provided without any doctor blade.

The object is also reached with a printing press according to claim 17.

An advantage with sealing assemblies of embodiments of the invention is that they may be introduced to ink reservoir and doctor blade assemblies without requiring any modification or replacement of the ink reservoir and doctor blade assemblies.

Further advantages and advantageous features of the invention are disclosed in the following description and in the dependent claims.

### BRIEF DESCRIPTION OF THE DRAWINGS

Below, embodiments of the invention will be described with reference to the drawings, in which:

FIG. 1 shows schematically a cross sectional view of parts of a printing press for flexographic printing with an ink reservoir and doctor blade assembly according to an embodiment of the invention,

FIG. 2 shows in a side view the ink reservoir and doctor blade assembly and a rotatable cylinder of the printing press, parts of which is shown in FIG. 1,

FIG. 3 shows a cross-section indicated by the arrows III-III in FIG. 2 of the ink reservoir and doctor blade assembly and the rotatable cylinder, and

FIG. 4-FIG. 13 show in respective cross-sections corresponding to the one in FIG. 3, respective ink reservoir and doctor blade assemblies according to respective further embodiments of the invention.

### DETAILED DESCRIPTION OF EMBODIMENTS OF THE INVENTION

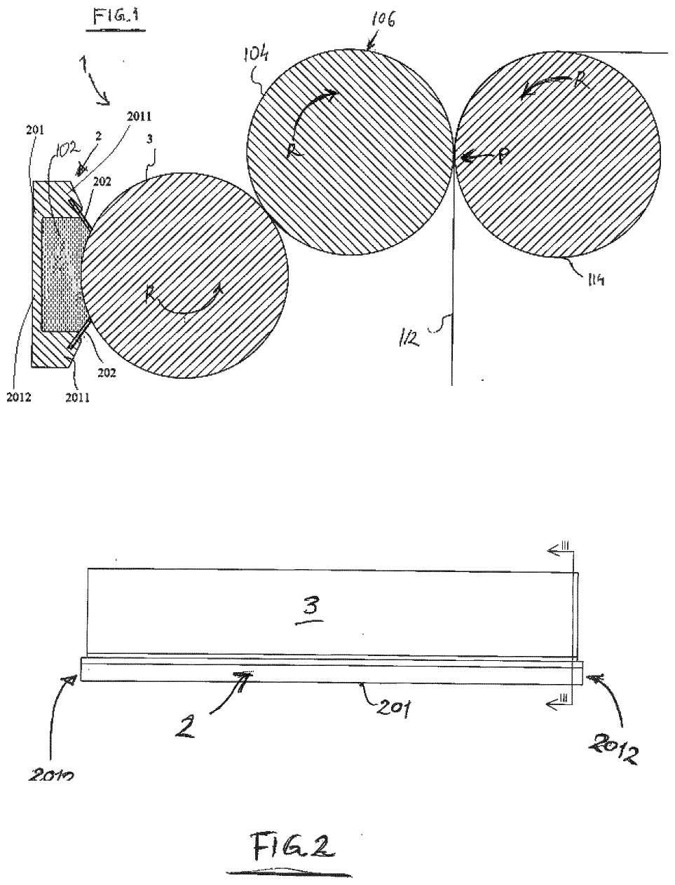

FIG. 1 shows schematically a cross sectional view of a printing press 1 for flexographic printing. The printing press comprises a first rotatable cylinder 3, also called anilox roller, that transfers ink 102 from an ink reservoir and doctor blade assembly 2 to a second rotatable cylinder 104. The anilox roller 3 transfers a uniform thickness of ink to a flexible printing plate 106 mounted on the second rotatable cylinder 104, also called plate cylinder.

The ink reservoir and doctor blade assembly 2 comprises a base 201 extending in the direction of the rotational axis of the first rotatable cylinder 3. The base comprises two walls 2011 and a root 2012 connecting the walls. The base has a U-shaped cross-section. The base extends along the first rotatable cylinder 3.

The ink reservoir and doctor blade assembly 2 comprises two doctor blades 202 which is fixed to respective walls 2011 of the ink reservoir and doctor blade assembly 2. The doctor blades are distributed on opposite sides of a longitudinal symmetry plane of the base 201. The doctor blades are in contact with the first rotatable cylinder 3. Thereby, the base and the doctor blades form a reservoir for the ink 102. The doctor blades 202 scrapes the first rotatable cylinder 3 to ensure that a uniform amount of ink 102 is delivered to the flexible printing plate 106.

An image formed on the printing plate 106 is transferred to an image-receiving substrate 112, in form of a web. The image-receiving substrate 112 is arranged to run between the second rotatable cylinder 104 and a third cylinder 114, also called impression cylinder or print anvil. The image is transferred during rotation R of the second rotatable cylinder 104 and at the same time by applying a pressure P to the second rotatable cylinder 104 by the third cylinder 114.

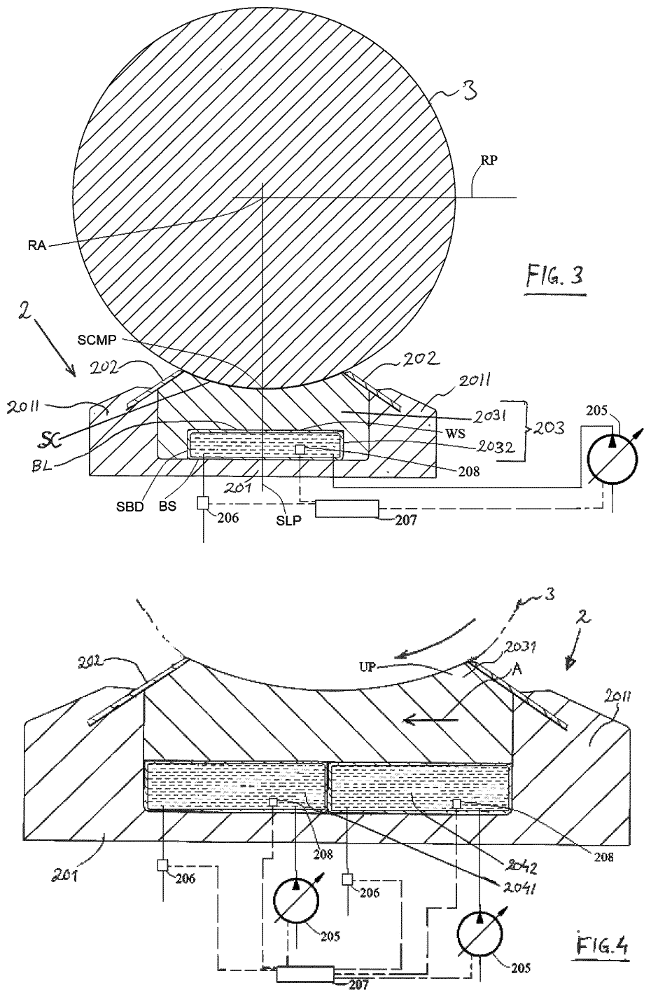

Reference is made also to FIG. 2 and FIG. 3. FIG. 2 shows the ink reservoir and doctor blade assembly 2 and the first rotatable cylinder 3 in a view from above in FIG. 1. FIG. 3 shows a cross-section as indicated by the arrows III-III in FIG. 2. This cross-section coincides with an axis perpendicular plane which is perpendicular to the rotational axis of the first rotatable cylinder 3, below merely referred to as the cylinder.

The ink reservoir and doctor blade assembly 2 comprises two sealing assemblies 203 for sealing respective axial ends 2012 of the ink reservoir and doctor blade assembly 2. It should be noted that a sealing assembly according to embodiments of the invention may also seal a sub-reservoir of the reservoir formed by the ink reservoir and doctor blade assembly 2 from another sub-reservoir of the reservoir.

One of the sealing assemblies can be seen in FIG. 3. The sealing assembly 203 comprises a seal 2031 presenting a seal contour SC to sealingly engage a circumferential surface of the cylinder 3. The seal 2031 also sealingly engages the doctor blades 202. The seal 2031 is made of a flexible material.

Further, the sealing assembly 203 comprises a flexible biasing device 2032. The biasing device 2032 may be provided in the form of a bladder. The bladder may be made in a suitable material, such as rubber. The bladder may be vulcanized so as to fit into a space delimed by the seal 2031 and the base 201.

The biasing device 2032 forms a cavity and is arranged to receive a pressurized fluid in the cavity. The biasing device 2032 serves to bias the seal 2031 into sealing engagement with the cylinder 3. The biasing device 2032 also serves to bias the seal 2031 into sealing engagement with the doctor blades 202.

The pressurization of the biasing device 2032 is provided by a pressurizing device. The pressurizing device comprises a fluid pump 205. The biasing device 2032 may be pressurized pneumatically or hydraulically. The fluid pump 205 may be a variable displacement pump. An adjustable valve 206 is arranged to release fluid from the biasing device so as to reduce the pressure therein.

The pressurizing device further comprises an adjustable valve 206, an electronic control unit 207, and a pressure sensor 208. The control unit 207 comprises a processor and a memory. The fluid pump 205 and the valve 206 are controllable to provide a pressure in the biasing device 2032 equal to a target pressure in the biasing device. For this the fluid pump and/or the valve are controllable by the control unit 207. The pressure sensor 208 is provided in the cavity of the biasing device 2032 to detect the pressure in the cavity. The control unit 207 is arranged to receive signals from the pressure sensor 208 representing the cavity pressure. The control unit 207 is arranged to control the fluid pump and/or the valve, in dependence on the cavity pressure, so as for the pressure in the cavity to be at the target pressure.

For this presentation, a seal location plane SLP is defined as coinciding with the rotational axis RA of the cylinder and a circumferential mid-point SCMP of the seal contour SC that sealingly engages the circumferential surface of the cylinder.

The biasing device 2032 is positioned with a back side BS thereof adjacent the base 201. The back side BS of the biasing device 2032 has a surface facing away from the cylinder 3. The back side BS is in contact with the base. In some embodiments, the base 2 may comprise a portion that is elevated towards the cylinder 3, wherein the back side BS of the biasing device 2032 is in contact with the elevated portion. The biasing device 2032 is in contact with the seal 2031 at the remaining sides of the biasing device 2032. Thereby, short sides and a long side of the biasing device 2032 are positioned in contact with the seal 2031. Furthermore, the biasing device 2032 is substantially symmetric in relation to the seal location plane SLP.

The seal 2031 extends along the short sides of the biasing device 2032. The short sides of the biasing device 2032 form engagement surfaces SBD of the biasing device 2032. Each engagement surface SBD is adapted to be substantially parallel with, i.e. have a normal which is substantially perpendicular to, the rotational axis RA of the cylinder 3, and to be oriented so that the engagement surface SBD faces away from the seal location plane SLP.

Thus, the engagement surfaces SBD extend, in a cross-section which is perpendicular to the cylinder rotational axis RA, in parallel with the seal location plane SLP, and face away from the seal location plane SLP, and the seal 2031 covers the engagement surfaces SBD.

It is understood that the biasing device has a constant cross-section along the rotational axis of the cylinder. Thereby, the engagement surfaces SBD have normals that are perpendicular to the cylinder rotational axis. However, as an alternative, the biasing device may have a non-constant cross-section along the rotational axis of the cylinder. Thereby, the engagement surfaces SBD have, although they extend, in a cross-section which is perpendicular to the cylinder rotational axis RA, in parallel with the seal location plane SLP, normals that are non-perpendicular to the cylinder rotational axis. Thereby, the engagement surfaces SBD face partly away from the seal location plane SLP.

Herein, any surface of the biasing device 2032 which is in contact with the seal 2031 is referred to as a border surface BL. The long side of the biasing device 2032 that is in contact with the seal 2031 forms a part of the border surface BL which faces the seal 2031, is planar, and extends parallel to the extending direction of the rotational axis of the cylinder 3. Any part of the border surface BL that faces at least partly towards the cylinder is herein also referred to as a work surface WS.

According to the embodiments shown in FIG. 2-FIG. 13, some of which are described below, the seal 2031 may be in direct contact with the doctor blades 202.

In the description below with reference to the embodiments shown in FIG. 4-FIG. 13, the same reference numerals are used for the corresponding features as shown and described with reference above to the embodiment shown in FIG. 2-FIG. 3.

FIG. 4 shows an ink reservoir and doctor blade assembly 2 according to another embodiment of the invention. In the embodiment, the biasing device 2032 forms two cavities 2041, 2042 and is arranged to receive the pressurized fluid in the cavities, for said biasing of the seal 2031 into sealing engagement with the cylinder 3. The flexible biasing device 2032 is arranged between the seal 2031 and the base 201 of the ink reservoir and doctor blade assembly 2.

The pressurization of the cavities 2041, 2042 of the biasing device 2032 is provided by a pressurizing device. The pressurizing device comprises two fluid pumps 205, two adjustable valves 206, two pressure sensors 208, and an electronic control unit 207.

The fluid pumps 205 are each arranged to pressurize a respective of the cavities. For each cavity, one of the valves 206 is arranged to release fluid from the cavity so as to reduce the pressure therein. The fluid pumps and/or the valves are controllable by the control unit 207. In each cavity one of the pressure sensors 208 is provided to detect the pressure in the respective cavity. The control unit 207 is arranged to receive signals from the pressure sensors 208 representing the cavity pressures. The control unit 207 is arranged to control the fluid pumps and/or the valves, in dependence on the cavity pressures, so as for the pressures in the cavities to be at respective target pressures.

FIG. 5 shows an ink reservoir and doctor blade assembly according to yet another embodiment of the invention, wherein the biasing device 2032 forms three cavities 2041-2043 and is arranged to receive the pressurized fluid in the cavities, for said biasing of the seal 2031 into sealing engagement with the cylinder. The flexible biasing device 2032 is arranged between the seal 2031 and the base 201 of the ink reservoir and doctor blade assembly 2.

As in the embodiment in FIG. 4, the pressurization of the cavities 2041-2043 of the biasing device 2032 is provided by a pressurizing device. The pressurizing device comprises three fluid pumps 205 (not shown in FIG. 5), three adjustable valves 206 (not shown in FIG. 5), three pressure sensors 208 (not shown in FIG. 5), and an electronic control unit 207 (not shown in FIG. 5).

Each of the fluid pumps is arranged to pressurize a respective of the cavities, and for each cavity, one of the valve is arranged to release fluid from the cavity so as to reduce the pressure therein. The fluid pumps and/or the valves are controllable by the control unit, arranged to receive signals from the pressure sensors in the cavities. The control unit is arranged to control the fluid pumps and/or the valves, in dependence on the cavity pressures, so as for the pressures in the cavities to be at respective target pressures.

In the embodiments shown in FIG. 4-FIG. 5, the pressurizing device is arranged so that the pressures in the cavities 2041, 2042, 2043 can be controlled individually. It should be noted that alternatively, in embodiments with three or more cavities, such as the one in FIG. 5, the pressurizing device is arranged so that the pressures in two or more of the cavities, but less than all the cavities, can be controlled together, but independently of the control of the pressure in the remaining cavity or cavities.

The biasing device 2032 is adapted so that the cavities 2041-2043 are distributed in the circumferential direction of the cylinder 3. As illustrated by the arrow A, during clockwise rotation of the cylinder 3, the flexible material of the seal 2031 may tend to move somewhat towards the left of the ink reservoir and doctor blade assembly 2 in FIG. 4. An upper portion UP (FIG. 4) of the seal 2031 at the right side may then be pressed away from its sealing engagement with the cylinder 3 and one of the doctor blades 202. By providing an increased pressure in the cavity 2042 closest below the upper portion UP of the seal 2031, the sealing engagement with the cylinder 3 can be secured and controlled.

Hence, different pressures can be provided to the cavities 2041, 2042, 2043. For instance, in the embodiment shown in FIG. 5, a lower pressure can be provided in the middle cavity 2043, while the cavities 2041, 2042 on each side can provided with a higher pressure.

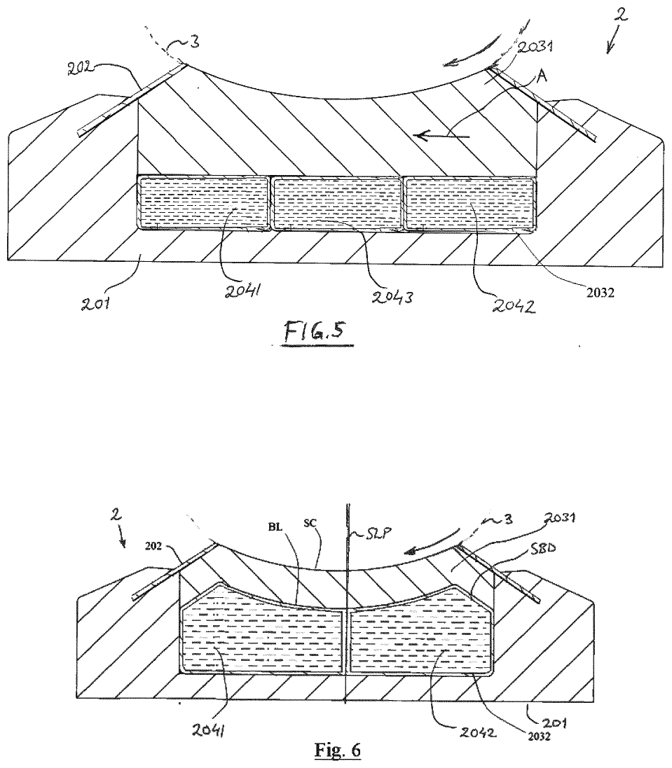

FIG. 6 shows an ink reservoir and doctor blade assembly 2 according to yet another embodiment of the invention. In this embodiment, the border surface BL of the flexible biasing device 2032 facing the seal 2031 has a central part with a curvature which is coaxial with the rotational axis of the cylinder 3.

On respective sides of the curved part, the border surface BL has portions which face partly away from the seal location plane SLP. Thereby, on the right in FIG. 6, the seal 2031 extends along a surface SBD of the biasing device 2032, i.e. one of said border surface portions, herein also referred to as an engagement surface. The engagement surface SBD is adapted to be substantially parallel with the axial direction of the cylinder 3, and to be oriented so that the surface SBD faces at least partly away from the seal location plane SLP.

By the engagement surface SBD, the seal 2031 partially encloses the biasing device 2032 in a plane which is perpendicular to the axis of the cylinder 3. Thereby an advantageous locking of the seal is achieved by means of the cylinder. The locking acts against the direction of rotation of the cylinder, and prevents the seal from moving in this direction of rotation.

Furthermore, the biasing device 2032 is substantially symmetric in relation to the seal location plane SLP.

The biasing device 2032 forms two cavities 2041, 2042. The biasing device 2032 is arranged to receive the pressurized fluid in the cavities, for biasing of the seal 2031 into sealing engagement with the cylinder 3 and the doctor blades 202. The biasing device 2032 is adapted so that the cavities 2041, 2042 are distributed in the circumferential direction of the cylinder 3. A pressurizing device may be arranged to provide different pressures to the cavities 2041, 2042, similarly to what was described above with reference to FIG. 4.

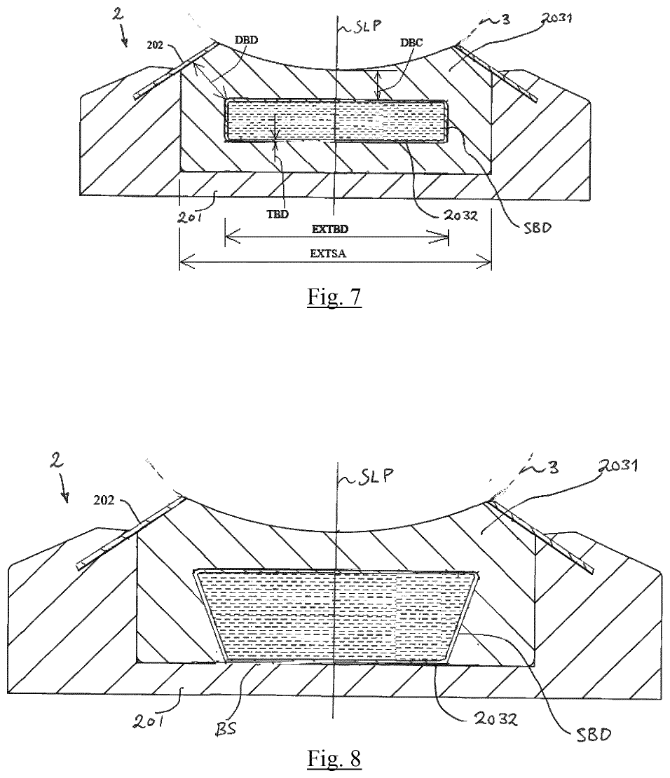

FIG. 7 shows an ink reservoir and doctor blade assembly 2 according to yet another embodiment of the invention. The biasing device 2032 is positioned within said seal. Thereby, the seal 2031 fully encloses the biasing device 2032. Furthermore, the biasing device 2032 is substantially symmetric in relation to the seal location plane SLP. The short sides of the biasing device 2032 form engagement surfaces SBD of the biasing device 2032. The engagement surfaces SBD are adapted to be substantially parallel with, i.e. have normals which are substantially perpendicular to, the axial direction of the cylinder 3, and to be oriented so that the engagement surfaces SBD face away from the seal location plane SLP.

Preferably, the biasing device 2032 has external walls with a thickness TBD of no more than 2% of the extension EXTSA of the sealing assembly 2031, 2032 along the reference plane. Preferably, extension EXTBD of the biasing device 2032 along the reference plane (RP in FIG. 3) is no more than 90%, preferably no more than 80%, of the extension EXTSA of the sealing assembly 2031, 2032 along the reference plane. Preferably, the shortest distance DBD between the biasing device 2032 and any of the doctor blades 202 is at least 1%, preferably at least 5%, more preferably at least 10%, of the extension EXTSA of the sealing assembly 2031, 2032 along the reference plane. Preferably, the shortest distance DBC between the biasing device 2032 and the cylinder 3 is at least 1%, preferably at least 5%, more preferably at least 10%, of the extension EXTSA of the sealing assembly 2031, 2032 along the reference plane.

Preferably the shortest distance DBC between the biasing device 2032 and the cylinder 3 is no more than 75%, preferably no more than 65%, of the shortest distance DBD between the biasing device 2032 and any of the doctor blades 202. However, in some embodiments, the shortest distance DBC between the biasing device 2032 and the cylinder 3 may be substantially the same as the shortest distance DBD between the biasing device 2032 and any of the doctor blades 202.

It should be noted that in some embodiments, the seal 2031 is deformed when the ink reservoir and doctor blade assembly is mounted to a cylinder 3. More specifically, before the ink reservoir and doctor blade assembly is mounted to the cylinder, the seal may have a straight contour between the doctor blades, and when the ink reservoir and doctor blade assembly is mounted to the cylinder 3, the seal is deformed so that it presents the seal contour SC to sealingly engage the circumferential surface of the cylinder.

FIG. 8 shows the ink reservoir and doctor blade assembly according to yet another embodiment of the invention. The biasing device 2032 is positioned with a back side BS thereof adjacent the base 201. The biasing device 2032 is surrounded by the seal 2031 at the other sides. Thereby, short sides and a long side of the biasing device 2032 are in contact with the seal. The short sides of the biasing device 2032 are inclined and diverge in the direction towards the cylinder 3. The long side is positioned centrally in the seal 2031 and is arranged parallel with the root of the base 201. Furthermore, the biasing device 2032 is substantially symmetric in relation to the seal location plane SLP. Each short side form an engagement surface SBD, which engagement surface SBD is adapted to be substantially parallel with the axial direction of the cylinder 3, and to be oriented so that the engagement surface SBD faces partly away from the seal location plane SLP.

Thus, the engagement surfaces SBD face partly away from a plane, (such as the reference plane RP in FIG. 3), which coincides with the rotational axis of the cylinder 3 and which is perpendicular to a seal location plane SLP.

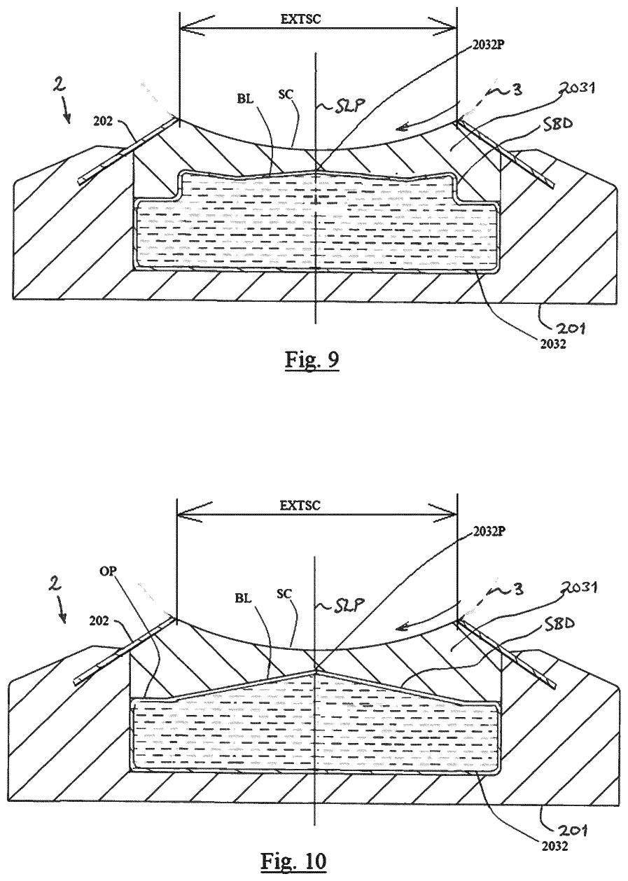

FIG. 9 shows an ink reservoir and doctor blade assembly according to yet another embodiment of the invention. A border surface BL of the flexible biasing device 2032 facing the seal 2031 extends substantially parallel to the rotational axis of the cylinder 3. The border surface BL is uneven in a direction which is perpendicular to the seal location plane SLP, i.e. in a direction which is parallel to a normal of the seal location plane SLP. Furthermore, the biasing device 2032 is substantially symmetric in relation to the seal location plane SLP. The border surface BL is provided with a central peak 2032P in the seal location plane SLP. The central peak 2032P is, compared to other parts of the biasing device, positioned closer to a plane which comprises the cylinder rotational axis and which is perpendicular to the seal location plane SLP, (such as the reference plane RP in FIG. 3). The central peak 2032P is located within an extension EXTSC of the seal contour SC along a plane which coincides with the rotational axis of the cylinder 3 and which is perpendicular to the seal location plane SLP, (such as the reference plane RP in FIG. 3).

The border surface BL is further provided with two peak formations symmetrically positioned at each side of the seal location plane SLP. Each of said further peak formations is directed towards a respective of the doctor blades 202. Each of said further peak formations form an engagement surface of the biasing device. Each engagement surface SBD is adapted to have a normal which is substantially perpendicular to the axial direction of the cylinder 3. The engagement surfaces SBD are arranged essentially parallel to the seal location plane SLP. The engagement surfaces SBD are oriented so to be facing away from the seal location plane SLP.

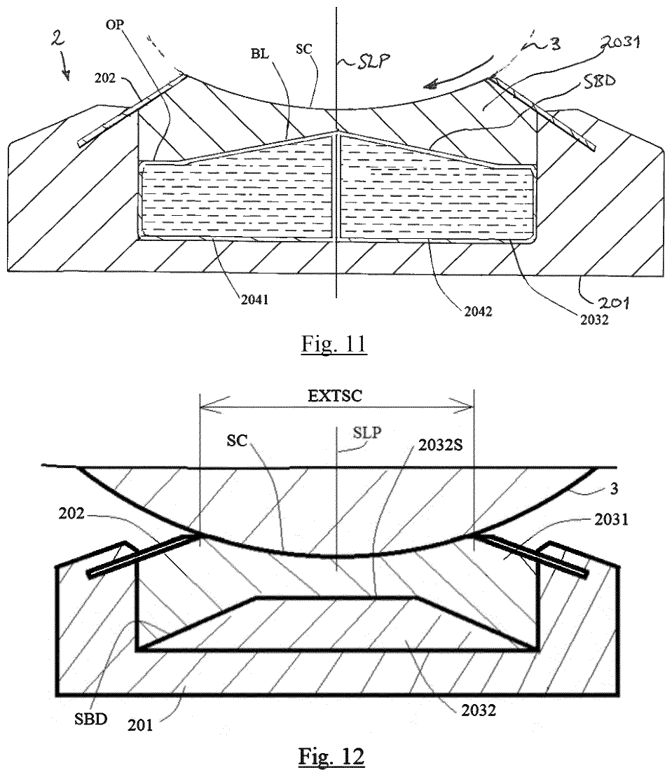

FIG. 10 shows an ink reservoir and doctor blade assembly according to yet another embodiment of the invention. The border surface BL of the flexible biasing device 2032 facing the seal 2031 forms a peak 2032P, with an inclined extension. The peak 2032P is located within an extension EXTSC of the seal contour SC along a plane which coincides with the rotational axis of the cylinder 3 and which is perpendicular to the seal location plane SLP, (such as the reference plane RP in FIG. 3). An engagement surface SBD of the biasing device extends on each side of the seal location plane SLP, starting from a position close to the walls of the base 201, towards a peak positioned in the seal location plane SLP. Said peak 2032P is, compared to other parts of the biasing device, positioned closer to a plane, (such as the reference plane RP in FIG. 3), which comprises the cylinder rotational axis and which is perpendicular to the seal location plane SLP. The border surface BL of the flexible biasing device 2032 is parallel to the root of the base 201 at outer portions OP close to the walls of the base 201, at the ends of the inclined extension. Furthermore, the biasing device 2032 is substantially symmetric in relation to the seal location plane SLP. The seal 2031 extends along the engagement surfaces SBD of the biasing device 2032, which engagement surfaces SBD are adapted to be oriented so that normals thereof are substantially perpendicular to the axial direction of the cylinder 3, and to be oriented so that the engagement surfaces SBD face partly away from the seal location plane SLP.

It should be noted that in some embodiments, the ink reservoir and doctor blade assembly may present the same features as the one described in FIG. 10, but with the following exception: The peak 2032P may be located at a distance from the seal location plane SLP, but still within the extension EXTSC of the seal contour SC along the plane which coincides with the rotational axis of the cylinder 3 and which is perpendicular to the seal location plane SLP, (such as the reference plane RP in FIG. 3).

FIG. 11 shows an ink reservoir and doctor blade assembly according to yet another embodiment of the invention. The embodiment is similar to the one shown in FIG. 10, except for the following difference: The biasing device 2032 forms two cavities 2041, 2042.

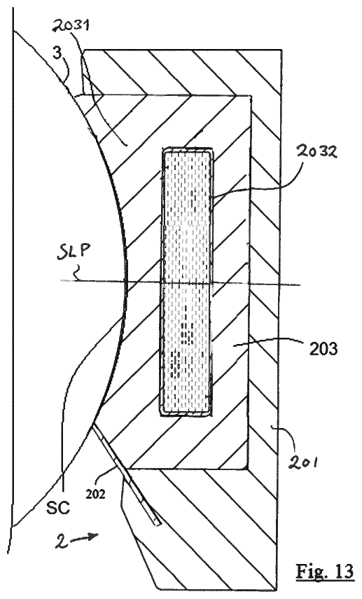

FIG. 12 shows an ink reservoir and doctor blade assembly according to yet another embodiment of the invention. The border surface BL of the flexible biasing device 2032 facing the seal 2031 forms a summit 2032S. The summit extends perpendicularly to the seal location plane SLP. The summit 2032S is located within an extension EXTSC of the seal contour SC along a plane which coincides with the rotational axis of the cylinder 3 and which is perpendicular to the seal location plane SLP, (such as the reference plane RP in FIG. 3). An inclined engagement surface SBD of the biasing device extends on each side of the summit 2032S.

FIG. 13 shows an ink reservoir and doctor blade assembly 2 according to yet another embodiment of the invention. The ink reservoir and doctor blade assembly 2 is located on a side of the cylinder. As in the embodiments described above, the ink reservoir and doctor blade assembly 2 comprises a base 201 extending in the direction of the rotational axis of the cylinder 3. The ink reservoir and doctor blade assembly 2 further comprises a single doctor blade 202 which is fixed to the base 201. The doctor blade is located at a lower part of the ink reservoir and doctor blade assembly 2. The cylinder 3, and the ink reservoir and doctor blade assembly 2 form a chamber for containing ink. The ink reservoir and doctor blade assembly 2 comprises a sealing assembly 203 for sealing an axial end of the chamber, or sealing a sub-chamber of the chamber from another sub-chamber of the chamber. The sealing assembly 203 comprises a seal 2031 presenting a seal contour SC to sealingly engage a circumferential surface of the cylinder 3. The seal 2031 is made of a flexible material. The sealing assembly 203 further comprises a flexible biasing device 2032 forming at least one cavity 2041-2043, and being arranged to receive a pressurized fluid in the cavity 2041-2043, for biasing the seal 2031 into sealing engagement with the cylinder 3. The seal 2031 fully encloses the biasing device 2032 in a plane that is perpendicular to the axis of the cylinder 3.

According to the embodiments of the invention as described with reference to the figures, the flexible seal material may be a flexible foam material. The foam material may be flexible as compared to the rigid U-shaped chamber and the rigid anilox roll. Further, the Young's modulus of the flexible seal material is equal to or less than 3000 MPa, preferably equal to or less than 2000 MPa, preferably equal to or less than 1300 MPa, preferably equal to or less than 500 MPa. Preferably, the Young's modulus of the flexible seal material is equal to or greater than 0.1 MPa, preferably equal to or greater than 0.2 MPa.

It is to be understood that the present invention is not limited to the embodiments described above and illustrated in the drawings; rather, the skilled person will recognize that many changes and modifications may be made within the scope of the appended claims.

1. A combination of an ink reservoir and doctor blade assembly and a rotatable cylinder for a printing press,
the ink reservoir and doctor blade assembly comprising a base extending in the direction of the rotational axis of the cylinder,
the ink reservoir and doctor blade assembly further comprising one or more doctor blades which are fixed to the base,
wherein the cylinder, and the ink reservoir and doctor blade assembly form a chamber for containing ink,
wherein the ink reservoir and doctor blade assembly comprises a sealing assembly for sealing an axial end of the chamber, or sealing a sub-chamber of the chamber from another sub-chamber of the chamber,
wherein the sealing assembly comprises a seal presenting a seal contour to sealingly engage a circumferential surface of the cylinder, and a flexible biasing device forming one or more cavities, and being arranged to receive a pressurized fluid in the one or more cavities, for biasing the seal into sealing engagement with the cylinder,
characterized in that the combination is arranged according to one or both of the following alternatives (a) and (b):
(a): in an axis perpendicular plane, which is perpendicular to the rotational axis of the cylinder and coincides with a cross-section of the biasing device, the biasing device has a peak or a summit which is located within an extension of the seal contour along a reference plane which coincides with the rotational axis of the cylinder and which is perpendicular to a seal location plane which coincides with the rotational axis of the cylinder and a circumferential mid-point of the seal contour,
(b): the biasing device presents one or more surfaces which extend, in the axis perpendicular plane, in parallel with the seal location plane, and which face at least partly away from the seal location plane, and/or one or more surfaces which face partly away from the reference plane, and the seal covers any such surface.

2. A combination according to claim 1, wherein the biasing device has a peak at, or in the vicinity of, the seal location plane.

3. A combination according to claim 1, wherein, in the axis perpendicular plane, the seal fully encloses the biasing device.

4. A combination according to claim 1, wherein the biasing device is positioned with a back side thereof adjacent the base, and is, in the axis perpendicular plane, surrounded by the seal at the remaining sides of the biasing device.

5. A combination according to claim 1, wherein the seal forms a single element.

6. A combination according to claim 1, wherein the seal and the biasing device are separate elements.

7. A combination according to claim 1, wherein the biasing device is in direct contact with the seal.

8. A combination according to claim 1, wherein the seal is in direct contact with the one or more doctor blades.

9. A combination according to claim 1, wherein the ink reservoir and doctor blade assembly comprises two doctor blades which are fixed to the base, wherein the seal contour is arranged to sealingly engage the circumferential surface of the cylinder between the doctor blades.

10. A combination according to claim 1, wherein the Young's modulus of the material of the seal is equal to or less than 3000 MPa.

11. A combination according to claim 1, wherein the biasing device forms at least two cavities and is arranged to receive the pressurized fluid in the cavities, for said biasing of the seal into sealing engagement with the cylinder.

12. A combination according to claim 1, wherein the cylinder is an anilox roll for a printing press for flexographic printing.

13. An ink reservoir and doctor blade assembly for a combination according to claim 1.

14. A sealing assembly for an ink reservoir and doctor blade assembly according to claim 13.

15. A reservoir assembly for a printing press, wherein the reservoir assembly is adapted to form, with a rotatable cylinder of the printing press, a chamber for containing ink, the reservoir assembly comprising:
a base adapted to extend in the direction of the rotational axis of the cylinder,
a sealing assembly for sealing an axial end of the chamber, or sealing a sub-chamber of the chamber from another sub-chamber of the chamber,
wherein the sealing assembly comprises a seal adapted to present a seal contour to sealingly engage a circumferential surface of the cylinder,
and a flexible biasing device arranged to receive a pressurized fluid for biasing the seal into sealing engagement with the cylinder,
characterized in that the biasing device forms two or more cavities, for receiving pressurized fluid,
wherein the reservoir assembly comprises a pressurizing device connected to the biasing device, such that the pressure in one or more, but less than all, of the cavities, can be controlled independently of a control of the pressure in the remaining cavity or cavities.

16. A reservoir assembly according to claim 16, wherein the biasing device is adapted so that the cavities are distributed in the circumferential direction of the cylinder.

17. A printing press comprising a combination according to claim 1.

18. A printing press comprising a reservoir assembly according to claim 15.
